(19) United States
(12) Patent Application Publication
(10) Pub. No.: US 2026/0309985 A1
(43) Pub. Date: Oct. 8, 2026

(54) ANGULAR OFFSET DISPLAY AND ILLUMINATION

(71) Applicant: Meta Platforms Technologies, LLC, Menlo Park, CA (US)

(72) Inventors: Fei Chen, Woodinville, WA (US); Scott Jeffrey Woltman, Seattle, WA (US)

(21) Appl. No.: 19/169,766

(22) Filed: Apr. 3, 2025

(51) Int. Cl. G02B 27/01

(52) U.S. Cl. CPC G02B 27/0172; G02B 2027/0112; G02B 2027/0178

(57) ABSTRACT

A display system includes a Liquid Crystal on Silicon (LCOS) display and a light source layer. The LCOS display includes LCOS display pixels arranged in rows and columns forming a rectangle. The LCOS display is configured to drive a digitally offset image onto an angularly offset portion of the LCOS display pixels that is angularly offset from the rectangle formed by the rows and columns. The light source layer includes an array of light sources angled to illuminate the angularly offset portion of the LCOS display pixels with illumination light.

### TECHNICAL FIELD

This disclosure relates generally to optics, and in particular to displays.

### BACKGROUND INFORMATION

Modern display technologies include liquid crystal displays (LCD) panels, projectors, organic light emitting diode (OLED) arrays, Liquid Crystal on Silicon (LCOS) displays, and even transparent displays. Common performance metrics of displays include brightness and contrast measurements. Certain display technologies are better suited for different contexts based on size, power, and desirable performance metrics. The form-factor or form-factor flexibility of the display technology can be a deciding factor when selecting a display, in some contexts.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 illustrates a head-mounted display (HMD) that may include an LCOS display system configured to drive a digitally offset image that is angularly offset, in accordance with aspects of the disclosure.

FIG. 2 illustrates an example LCOS system that may include an LCOS display configured to drive a digitally offset image that is angularly offset, in accordance with aspects of the disclosure.

FIG. 3 illustrates an example LCOS system that may include an LCOS display configured to drive a digitally offset image that is angularly offset, in accordance with aspects of the disclosure.

FIG. 4 illustrates example LCOS display pixels arranged in rows and columns forming rectangle, in accordance with aspects of the disclosure.

FIG. 5 illustrates LCOS display pixels arranged in rows and columns forming a rectangle, in accordance with aspects of the disclosure.

FIG. 6A illustrates an illuminated portion of the LCOS display pixels that are illuminated by light sources in a light source layer, in accordance with aspects of the disclosure.

FIG. 6B illustrates a digitally offset image driven onto the angularly offset portion of LCOS display pixels, in accordance with aspects of the disclosure.

FIG. 6C illustrates that a reflective surface may be angled to assist in rectifying the display light of the angularly offset image, in accordance with aspects of the disclosure.

FIGS. 7A-8B illustrate light source layers angled to illuminate the angularly offset portion of LCOS display pixels with illumination light, in accordance with aspects of the disclosure.

FIG. 9 illustrates a process of operating a digital angular offset display, in accordance with aspects of the disclosure.

### DETAILED DESCRIPTION

Embodiments of angular offset displays and illumination are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In some implementations of the disclosure, the term “near-eye” may be defined as including an element that is configured to be placed within 50 mm of an eye of a user while a near-eye device is being utilized. Therefore, a “near-eye optical element” or a “near-eye system” would include one or more elements configured to be placed within 50 mm of the eye of the user.

In aspects of this disclosure, visible light may be defined as having a wavelength range of approximately 380 nm-700 nm. Non-visible light may be defined as light having wavelengths that are outside the visible light range, such as ultraviolet light and infrared light. Infrared light having a wavelength range of approximately 700 nm-1 mm includes near-infrared light. In aspects of this disclosure, near-infrared light may be defined as having a wavelength range of approximately 700nm-1.6 μm.

In aspects of this disclosure, the term “transparent” may be defined as having greater than 90% transmission of light. In some aspects, the term “transparent” may be defined as a material having greater than 90% transmission of visible light.

LCOS displays may use LEDs or lasers as light sources. In order to generate a color image, red, green, and blue light sources may be illuminated sequentially while pixels of the LCOS are modulated in sync with the red, green, and blue light sources to generate red, green, and blue images that combine to generate the color images. Each red, green, or blue light source may only be illuminated for 20 ms or less to generate each sub-frame that combines into color image frame.

LCOS displays typically include a rectangular LCOS pixel array of LCOS pixels that are arranged in rows and columns. In the context of Augment Reality (AR) glasses, display light from the LCOS display is directed into a waveguide that directs the display light to an eyebox region to present virtual images to a wearer of the AR glasses. However, the design and alignment of the waveguide with the rectangular array of the LCOS pixel array may limit the design freedom for placement of the LCOS pixel array. This lack of design freedom may constrain the overall shape of the AR glasses and result in unwanted protrusions to the overall form-factor of the AR glasses.

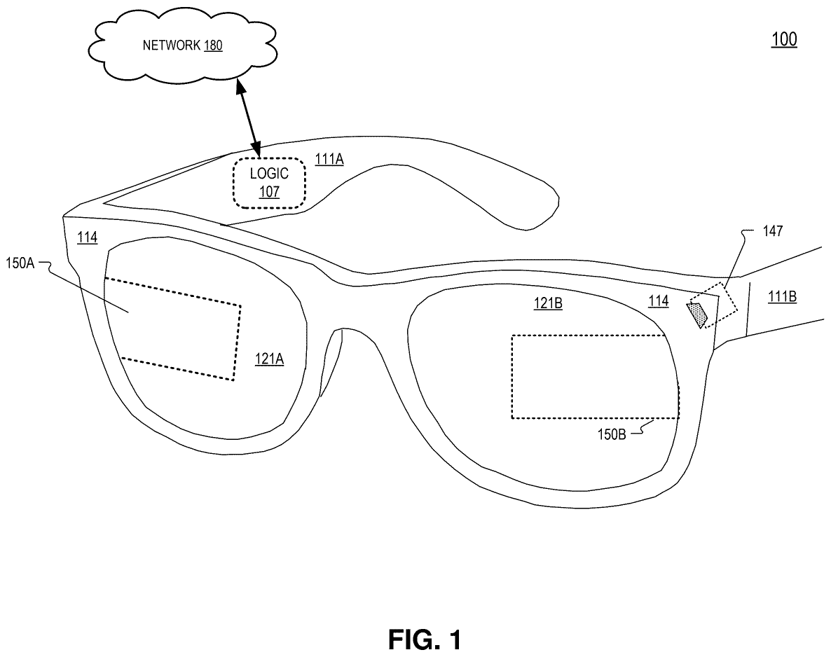

In implementations of the disclosure, a head-mounted display (HMD) such as AR glasses includes an LCOS display including LCOS display pixels arranged in rows and columns forming a rectangle. The LCOS display is configured to drive digitally offset images onto an angularly offset portion of the LCOS display pixels that is angularly offset from the rectangle formed by the rows and columns. The digitally offset image that is angularly offset allows a display assembly to be positioned within a smaller (and more desirable) form factor of the HMD while still delivering the display light to the waveguide for presentation to an eyebox region. A light source layer that illuminates the LCOS display may also be angularly tilted to support illuminating the angularly offset portion of the LCOS display (without illuminating a remainder of the LCOS display pixels that won't be driven to generate the virtual image). While driving the image on only a portion of the LCOS display is counterintuitive since it reduces the resolution of the image, the gains in form-factor design freedom are significant and the resolution loss can be engineered to be slight, in accordance with features disclosed herein. These and other embodiments are described in more detail in connection with FIGS. 1-9.

FIG. 1 illustrates a head-mounted display (HMD) 100 that may include an LCOS display system configured to drive a digitally offset image that is angularly offset, in accordance with aspects of the present disclosure. HMD 100 includes frame 114 coupled to arms 111A and 111B. Lens assemblies 121A and 121B are mounted to frame 114. Lens assemblies 121A and 121B may include a prescription lens matched to a particular user of HMD 100. The illustrated HMD 100 is configured to be worn on or about a head of a wearer of HMD 100.

In the HMD 100 illustrated in FIG. 1, each lens assembly 121A/121B includes a waveguide 150A/150B to direct image light generated by display engine to an eyebox region for viewing by a user of HMD 100. Display engine 147 is illustrated as being located proximate to a temple region where frame 114 and arm 111B meet. Display engine 147 directs image light to waveguide 150B. Display engine 147 may include a liquid crystal on silicon (LCOS) display for directing image light to a wearer of HMD 100 to present virtual images, for example. The LCOS display may include a light source that includes mini-LEDs or laser diodes. While not particularly illustrated in FIG. 1, a second display engine may direct image light to waveguide 150A so that image light may be directed to both eyes of a user of HMD 100.

Lens assemblies 121A and 121B may appear transparent to a user to facilitate augmented reality or mixed reality to enable a user to view scene light from the environment around them while also receiving image light directed to their eye(s) by waveguides 150, for example. Lens assemblies 121A and 121B may include two or more optical layers for different functionalities such as display, eye-tracking, and optical power. In some embodiments, display light from display engines (e.g. display engine 147) is only directed into one eye of the wearer of HMD 100. In an embodiment, two display engines are used to direct image light into waveguides 150A and 150B, respectively.

Frame 114 and arms 111 may include supporting hardware of HMD 100 such as processing logic 107, a wired and/or wireless data interface for sending and receiving data, graphic processors, and one or more memories for storing data and computer-executable instructions. Processing logic 107 may include circuitry, logic, instructions stored in a machine-readable storage medium, ASIC circuitry, FPGA circuitry, and/or one or more processors. In one embodiment, HMD 100 may be configured to receive wired power. In one embodiment, HMD 100 is configured to be powered by one or more batteries. In one embodiment, HMD 100 may be configured to receive wired data including video data via a wired communication channel. In one embodiment, HMD 100 is configured to receive wireless data including video data via a wireless communication channel. Processing logic 107 may be communicatively coupled to a network 180 to provide data to network 180 and/or access data within network 180. The communication channel between processing logic 107 and network 180 may be wired or wireless.

HMD 100 may include a camera (not specifically illustrated)configured to image an eyebox region. In some implementations, an illumination module (not specifically illustrated) may illuminate the eyebox region with near-infrared illumination light to assist the camera in imaging the eyebox region for eye-tracking purposes. The camera may include a lens assembly configured to focus image light to a complementary metal-oxide semiconductor (CMOS) image sensor, in some implementations. A near-infrared filter that receives a narrow-band near-infrared wavelength may be placed over the image sensor so it is sensitive to the narrow-band near-infrared wavelength while rejecting visible light and wavelengths outside the narrow-band. Near-infrared illuminators (not illustrated) such as near-infrared LEDs or laser diodes that emit the narrow-band wavelength may be included in the illumination module to illuminate the eyebox region with the narrow-band near-infrared wavelength.

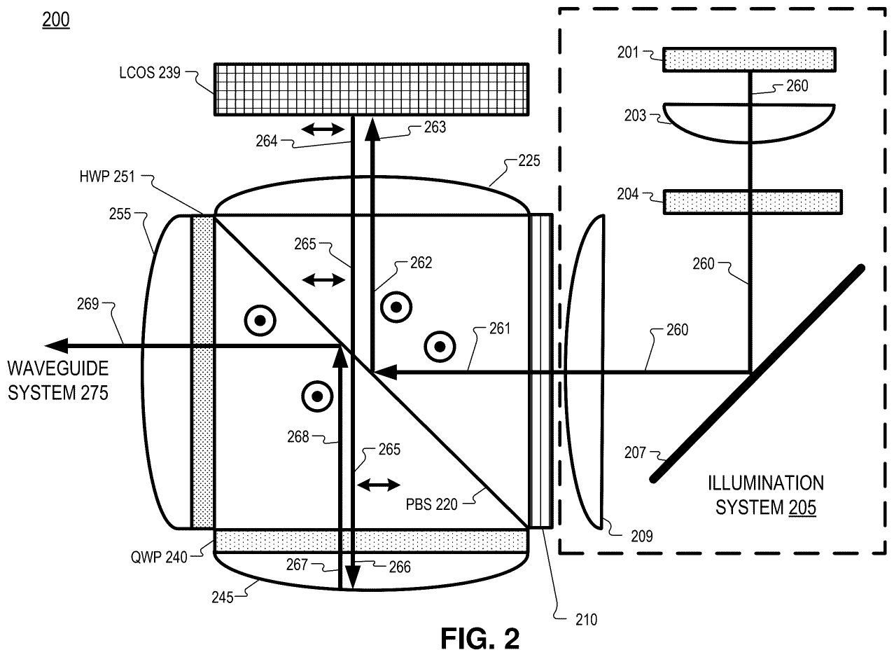

FIG. 2 illustrates an example LCOS system 200 that may include an LCOS display configured to drive a digitally offset image that is angularly offset, in accordance with aspects of the disclosure. LCOS system 200 includes illumination system 205 including a light source layer 201. Light source layer 201 may include mini-LEDs, LEDs, or lasers disposed on an electronic substrate. There may be one or more red LEDs, green LEDs, blue LEDs in light source layer 201, for example. There may be one or more red mini-LEDs, green mini-LEDs, blue mini-LEDs in light source layer 201. There may be one or more red laser diodes, green laser diodes, and blue laser diodes in light source layer 201, in some examples. Light source layer 201 may receive (or generate) illumination signals to sequentially turn on the red, green, and blue light sources to generate illumination light 260. Illumination system 205 includes more than one color channel so that the display light generated by LCOS system 200 includes color images. In some implementations, illumination system 205 includes red, green, and blue (RGB) light sources that emit light sequentially and the red, green, and blue portions of an image are driven onto LCOS 239 in concert with illumination system 205 sequentially emitting the red, green, and blue illumination light.

Illumination system 205 may include focusing optics 203 configured to focus illumination light 260 to mirror 207. Focusing optics 203 may include one or more refractive lenses. A polarizing element 204 may be optionally disposed between light source layer 201 and mirror 207 to polarize illumination light 260 to a particular polarization orientation. Illumination system 205 may also include focusing optics 209 to further focus illumination light 260 after illumination light 260 reflects off mirror 207 and propagates toward polarizing beam splitter (PBS) 220.

LCOS system 200 may further include a pre-polarizer 210, polarized beam splitter (PBS) 220, a lens 225, an LCOS 239, a quarter-waveplate (QWP) 240, a reflector 245, a half-waveplate (HWP) 251, a lens 255, and a waveguide system 275.

In operation, illumination light 260 is emitted from illumination system 205 and propagates along optical path 261 toward pre-polarizer 210. Pre-polarizer 210 passes a first linear polarization orientation of the light so the illumination light has a homogeneous polarization orientation. PBS 220 is configured to reflect the first linear polarization orientation and pass a second linear polarization orientation that is orthogonal to the first linear polarization orientation. Thus, the illumination light having the first linear polarization orientation reflects off PBS 220 and is redirected toward LCOS 239 along optical path 262.

Lens 225 may focus the illumination light propagating along optical path 262 to generate compensated illumination light 263 that encounters LCOS 239. Lens 225 may be a refractive lens. Lens 225 may be considered a field lens.

LCOS 239 receives compensated illumination light 263 and is configured to modulate the compensated illumination light to generate display light. Images may be driven on an LCOS pixel array of LCOS 239. The LCOS pixel array may be arranged in rows and columns and each LCOS pixel in the LCOS pixel array may be modulated to reflect light or to block light. To generate color images, a red image sub-frame, a green image sub-frame, and a green image sub-frame may be sequentially driven onto LCOS 239 (in concert with red, green, and blue illumination light from light source layer 201) to generate a color image frame. The time duration of the color image frame may be less than 50 ms. The sub-frames may be approximately a third of the time of the time duration of the color image frame. In some implementations, the time duration of the color frame is approximately 33 ms, which corresponds with a frame rate of approximately 30 Hz. In some implementations, the time duration of the color frame is approximately 16 ms, which corresponds with a frame rate of approximately 60 Hz. In some implementations, the time duration of the color frame is approximately 8 ms, which corresponds with a frame rate of approximately 120 Hz.

Display light 264 generated by LCOS 239 is received by lens 225 and exits as compensated display light 265. Compensated display light 265 may have a second linear polarization orientation orthogonal to the first linear polarization orientation of illumination light 262. Since PBS 220 is configured to pass the second linear polarization orientation and reflect the first linear polarization orientation, the compensated display light 265 (having the second linear polarization orientation) passes through PBS 220 and retains its second linear polarization orientation.

The compensated display light 265 encounters QWP 240. QWP 240 is configured to shift the polarization axis of incident light such that linearly polarized light may be converted to circularly polarized light by QWP 240. Likewise, incident circularly polarized light may be converted to linearly polarized light by QWP 240. QWP 240 may be made of birefringent materials such as quartz, organic material sheets, or liquid crystal, for example. In one embodiment, QWP 240 is designed to be a so called “zero order waveplate” so that the retardance imparted by the QWP 240 remains close to a quarter of a wave independent of the wavelength and angle of incidence of incoming light.

The compensated display light 265 having the second linear polarization is converted to circularly polarized light propagating along optical path 266 prior to encountering reflector 245. Reflector 245 may include a lensing curvature to assist in focusing the compensated display light. The circularly polarized light propagating along optical path 266 reflects off reflector 245 which changes the orientation of the light propagating along optical path 267 to the opposite-handed circularly polarized light than that of the circularly polarized light propagating along optical path 266. The light propagating along optical path 267 is then converted to linearly polarized light by QWP 240.

As shown in FIG. 2, the light propagating along optical path 268 is in the first linear polarization orientation and is reflected by PBS 220 toward waveguide system 275. Waveguides 150A/150B in FIG. 1 may be an example of waveguide system 275. The light directed toward waveguide system 275 by PBS 220 retains its first linear polarization orientation and encounters HWP 251. HWP 251 is configured to shift the polarization axis of incident light by π/2 (90 degrees). Therefore, in some implementations, linearly polarized light may be converted by HWP 251 to an orthogonal orientation of the linearly polarized light reflecting from PBS 220 toward waveguide system 275. In other implementations, light encountering HWP 251 may be converted to a different polarization direction that is not necessarily orthogonal to the received light. HWP 251 may be designed to be a so called “zero order waveplate” so that the retardance imparted by HWP 251 remains close to half of a wave independent of the wavelength and angle of incidence of incoming light.

Waveguide system 275 is configured to receive the display light propagating along optical path 269. Waveguide system 275 may be configured to direct virtual images included in the display light to an eyebox region. The waveguide system 275 may include one or more mirrors, half-mirrors, gratings, or diffractive optical elements to incouple the display light into the waveguide, direct the display light within the waveguide system, and outcouple the display light from the waveguide toward the eyebox region. Waveguides 150A/150B in FIG. 1 may be an example of waveguide system 275. Waveguide system 275 may include a geometric waveguide. The geometric waveguide may have one or more mirrors or reflectors that assist in directing the display light to eyebox region. Geometric waveguides use the shape of the waveguide to control the optical path of the display light (in contrast to a strict rectangle waveguide). Therefore, a geometric waveguide may include bevels or angled features (optionally paired with reflectors, mirrors, or half-mirrors) to assist in directing the display light to the eyebox region. The eyebox region may be the region that an eye of a user would occupy when wearing HMD 100, for example.

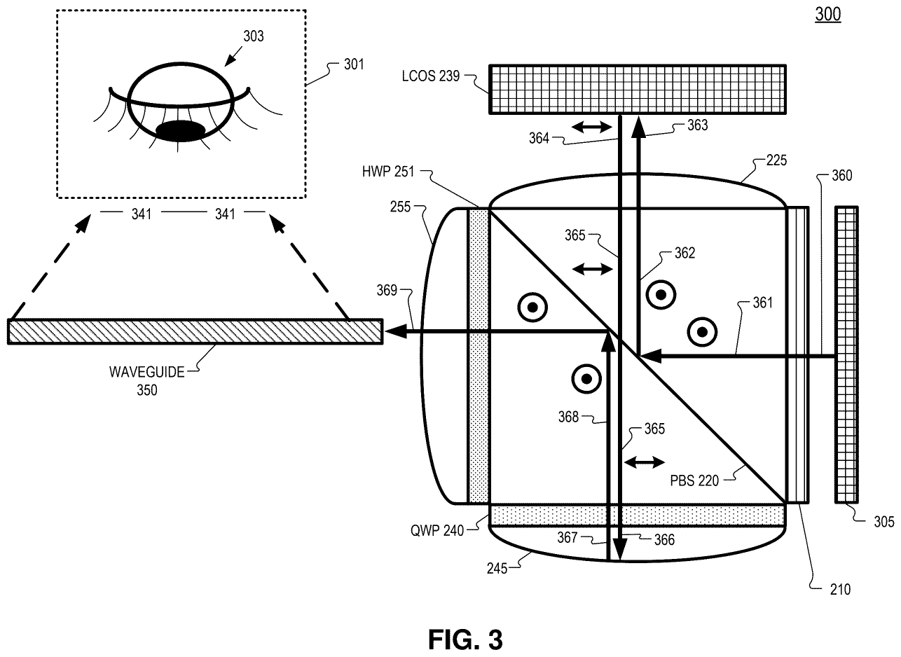

FIG. 3 illustrates an example LCOS system 300 that may include an LCOS display configured to drive a digitally offset image that is angularly offset, in accordance with aspects of the disclosure. LCOS system 300 also includes illumination system 305. Illumination system 305 may be significantly more compact than illumination system 205 due to the use of a metalens that is planar and configured to focus illumination light to LCOS 239. The illumination light 360 that is focused by the metalens may be generated by an array of mini-LED disposed on a planar driver substrate, for example.

LCOS system 300 has similarities to LCOS system 200. In operation, illumination light 360 is emitted from illumination system 305 and propagates toward pre-polarizer 210. Pre-polarizer 210 passes a first linear polarization orientation of the light so the illumination light has a homogeneous polarization orientation. PBS 220 is configured to reflect the first linear polarization orientation and pass a second linear polarization orientation that is orthogonal to the first linear polarization orientation. Thus, the illumination light having the first linear polarization orientation reflects off PBS 220 and is redirected toward LCOS 239 along optical path 362.

Lens 225 may focus the illumination light propagating along optical path 362 to generate compensated illumination light 363 that encounters LCOS 239. LCOS 239 receives compensated illumination light 363 and is configured to modulate the compensated illumination light to generate display light. Images may be driven on an LCOS pixel array of LCOS 239. The LCOS pixel array may be arranged in rows and columns and each LCOS pixel in the LCOS pixel array may be modulated to reflect light or to block light. To generate color images, a red image sub-frame, a green image sub-frame, and a green image sub-frame may be sequentially driven onto LCOS 239 (in concert with red, green, and blue illumination light from mini-LEDs in illumination system 305) to generate a color image frame. The time duration of the color image frame may be less than 50 ms. The sub-frames may be approximately a third of the time of the time duration of the color image frame. In some implementations, the time duration of the color frame is approximately 33 ms, which corresponds with a frame rate of approximately 30 Hz. In some implementations, the time duration of the color frame is approximately 16 ms, which corresponds with a frame rate of approximately 60 Hz. In some implementations, the time duration of the color frame is approximately 8 ms, which corresponds with a frame rate of approximately 120 Hz.

Display light 364 generated by LCOS 239 is received by lens 225 and exits as compensated display light 365. Compensated display light 365 may have a second linear polarization orientation orthogonal to the first linear polarization orientation of illumination light 362. Since PBS 220 is configured to pass the second linear polarization orientation and reflect the first linear polarization orientation, the compensated display light 365 (having the second linear polarization orientation) passes through PBS 220 and retains its second linear polarization orientation.

The compensated display light 365 encounters QWP 240. The compensated display light 365 having the second linear polarization is converted to circularly polarized light propagating along optical path 366 prior to encountering reflector 245. The circularly polarized light propagating along optical path 366 reflects off reflector 245 which changes the orientation of the light propagating along optical path 367 to the opposite-handed circularly polarized light than that of the circularly polarized light propagating along optical path 366. The light propagating along optical path 367 is then converted to linearly polarized light by QWP 240.

As shown in FIG. 3, the light propagating along optical path 368 is in the first linear polarization orientation and is reflected by PBS 220 toward waveguide system 350. Waveguides 150A/150B in FIG. 1 may be an example of waveguide system 350. The light directed toward waveguide system 350 by PBS 220 retains its first linear polarization orientation and encounters HWP 251. HWP 251 is configured to shift the polarization axis of incident light by π/2 (90 degrees). Therefore, in some implementations, linearly polarized light may be converted by HWP 251 to an orthogonal orientation of the linearly polarized light reflecting from PBS 220 toward waveguide system 350. Waveguide system 350 may rely on mirrors or diffractive incoupling elements to incouple the display light into waveguide system 350. Waveguide system 350 may rely on mirrors or diffractive outcoupling elements to outcouple the display to the eyebox region 301.

Waveguide system 350 is configured to receive the display light (from the LCOS 239) propagating along optical path 369 and redirect the display light. Waveguide system 350 may be configured to direct virtual images 341 included in the display light to eyebox region 301. Waveguide system 350 may have the features described with respect to waveguide system 275. Eyebox region 301 may be the region that an eye 303 of a user would occupy when wearing HMD 100, for example.

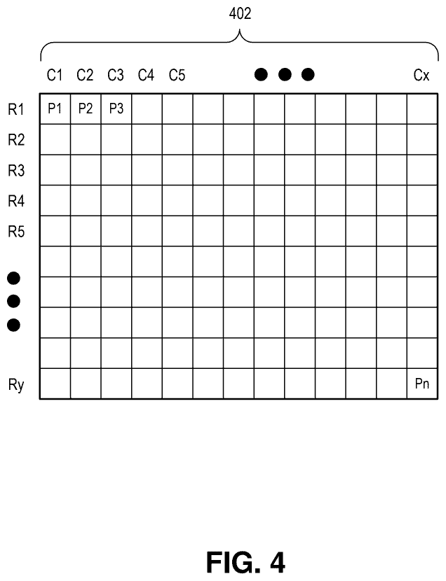

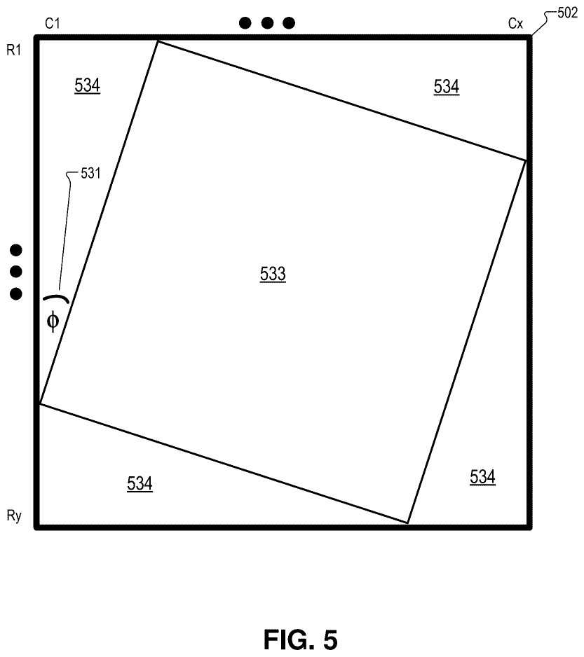

FIG. 4 illustrates an example LCOS display pixels 402 arranged in rows and columns forming rectangle, in accordance with aspects of the disclosure. The example LCOS display pixels 402 include integer x columns (C1, C2, C3, C4, C5 . . . proceeding to Cₓ columns) and integer y rows (R1, R2, R3, R4, R5 . . . proceeding to R_{y}) where integer x multiplied by integer y equates to integer n pixels (P1, P2, P3 . . . proceeding to Pₙ). There may be hundreds of pixel rows and hundreds of pixel columns, in some implementations. There may be one thousand or more pixel rows and one thousand or more pixel columns, in some implementations.

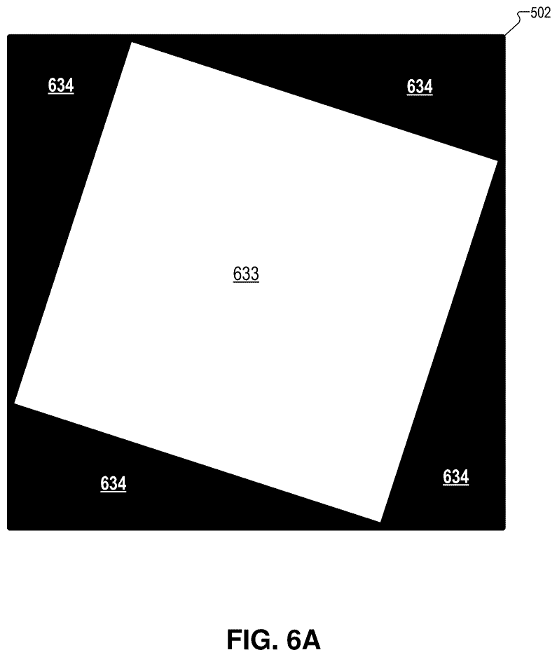

FIG. 5 illustrates LCOS display pixels 502 arranged in rows and columns forming a rectangle, similar to LCOS display pixels 402, in accordance with aspects of the disclosure. FIG. 5 shows an angularly offset portion 533 of LCOS display pixels 502 that is angularly offset from a rectangle formed by the rows R_{y} and the columns Cₓ. In FIG. 5, the angularly offset portion 533 of LCOS display pixels 502 is offset from the rectangle formed by the rows R_{y} and the columns Cₓ by an offset angle 531 (φ). In implementations of the disclosure, angle 531 is between 10 degrees and 45 degrees. In implementations of the disclosure, angle 531 is between 20 degrees and 40 degrees. In implementations of the disclosure, only the angularly offset portion 533 of LCOS display pixels 502 are driven with an image and the remainder 534 of the LCOS display pixels 502 (that are not included in the angularly offset portion 533) are driven to a dark pixel value. The angularly offset portion 533 of the LCOS display pixels 502 is a smaller subset of the total integer number n of the LCOS display pixels 502. The sum of the angularly offset portion 533 of LCOS display pixels 502 and the remainder 534 of the LCOS display pixels 502 is the integer n found by multiplying the number of rows y with the number of columns x.

In the illustrated implementation, the angularly offset portion 533 of LCOS display pixels 502 is approximately rectangular. In some implementations, all the corners of the angularly offset portion 533 of LCOS display pixels 502 are on the outermost rows or columns of LCOS display pixels 502 to maximize the resolution of the image that the angularly offset portion 533 can display. In some implementations, the remainder 534 of the LCOS display pixels 502 are separated into four separate portions that are separated by the angularly offset portion 533 of LCOS display pixels 502.

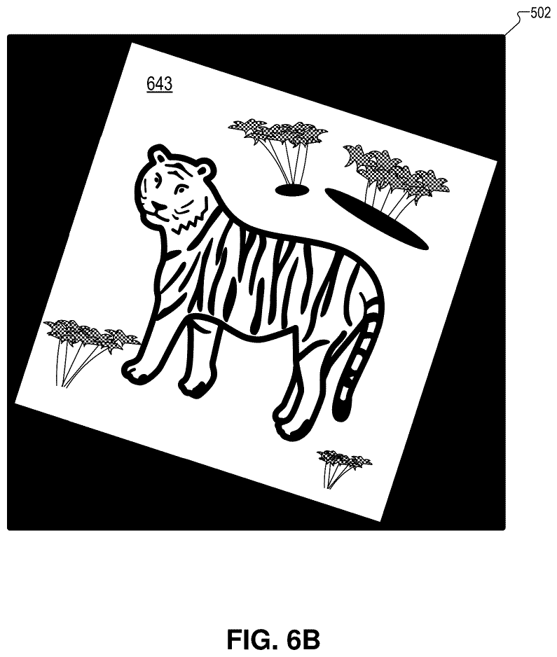

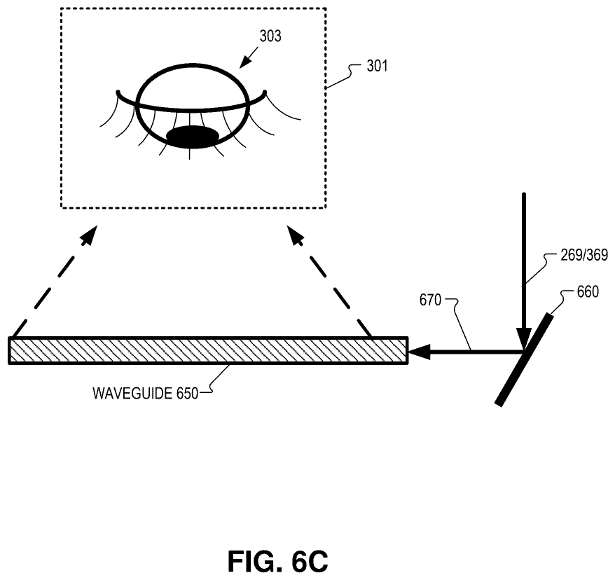

FIG. 6A illustrates an illuminated portion 633 of the LCOS display pixels that are illuminated by light sources in a light source layer, in accordance with aspects of the disclosure. Since only angularly offset portion 533 will be used to present an image to the eyebox region, the remainder 534 of the LCOS display pixels 502 need not be illuminated and electrical energy can be saved by illuminating the illuminated portion 633 corresponding to the angularly offset portion 533 with illumination light without substantially illuminating an unilluminated portion 634 corresponding to the remainder 534 of the LCOS display pixels 502.

FIG. 6B illustrates a digitally offset image 643 driven onto the angularly offset portion 533 of LCOS display pixels 502, in accordance with aspects of the disclosure. Digitally offset image 643 includes a tiger amongst plants. Notably, the tiger and the plants are digitally offset at approximately the same angle as offset angle 531. Digitally offset image 643 will ultimately be presented as a virtual image to an eyebox region where the tiger is standing straight up (not offset) from the perspective of a user. In some implementations, the geometry of the waveguide system rectifies digitally offset image 643 to be straight up and down when it is delivered to the eyebox region.

FIG. 6C illustrates that a reflective surface 660 may be angled to assist in rectifying the display light of the angularly offset image, in accordance with aspects of the disclosure. In some implementations, a reflective surface 660 (e.g. a mirror, half-mirror, or grating) is angled with respect to display light 269 or 369 including digitally offset image 643 to rectify the digitally offset image 643 to be straight up and down when it is delivered to the eyebox region 301. In some implementations, reflective surface 660 is angles between 20 degrees and 75 degrees with respect to the display light 269/369 incident on the reflective surface 660. In some implementations, reflective surface 660 is angles between 50 degrees and 70 degrees with respect to the display light 269/369 incident on the reflective surface 660. In the illustrated implementation, the reflective surface 660 is disposed in the optical path between the LCOS display 239 and the waveguide system 650. In some implementations, reflective surface 660 is part of waveguide system 650. Waveguide system 650 may include waveguide system 275 or waveguide system 350, for example. In some implementations, a combination of the reflective surface 660 and the geometry of the waveguide provide the rectification of digitally offset image 643 to be straight up and down when it is delivered to the eyebox region 301.

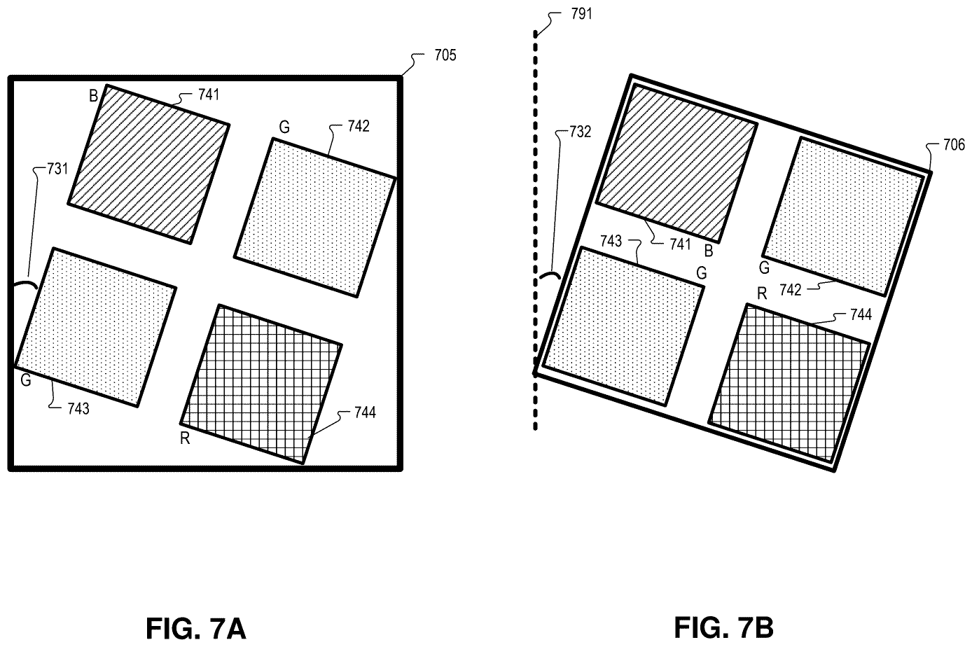

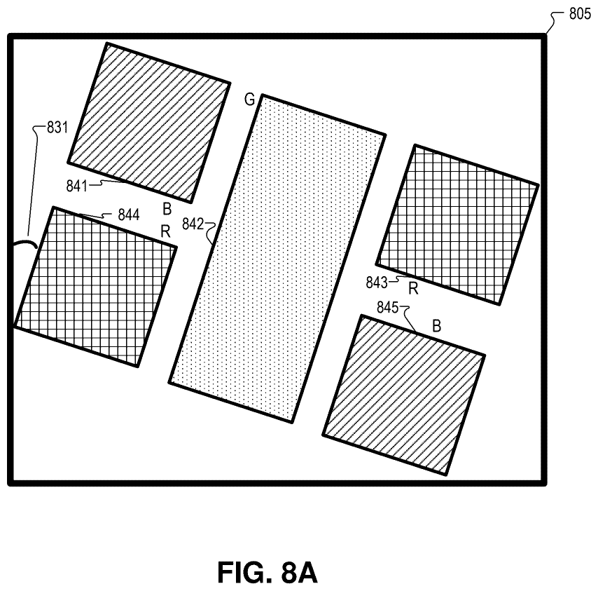

FIGS. 7A and 7B illustrate light source layers angled to illuminate the angularly offset portion 533 of LCOS display pixels 502 with illumination light, in accordance with aspects of the disclosure. FIG. 7A illustrates an example light source layer 705 including four light sources 741, 742, 743, and 744. In FIG. 7A, light sources 741, 742, 743, and 744 are angled at angle 731 that approximates offset angle 531. In FIG. 7A, the edge of a substrate of light source layer 705 may be aligned with an edge rectangular shape of LCOS display pixels 502. In FIG. 7A, light sources 741, 742, 743, and 744 include rectangular emission regions and the sides of the rectangular emission regions are angularly offset by the offset angle 531 to match the angularly offset image 643. FIG. 7A shows that light source 741 is a blue light source emitting blue illumination light and light source 744 is a red light source emitting red illumination light. Light sources 742 and 743 are illustrated as green light sources emitting green illumination light. In FIG. 7A, the light sources in light source layer 705 consist of two green LEDs, one red LED, and one blue LED. Light sources 741, 742, 743, and 744 may be mini-LEDs or laser diodes.

FIG. 7B illustrates an example light source layer 706 including four light sources 741, 742, 743, and 744. In FIG. 7B, light sources 741, 742, 743, and 744 are angled at angle 732 that approximates offset angle 531. In FIG. 7B, the edge of a substrate of light source layer 706 may be aligned with the edge of the angularly offset portion 533 of LCOS display pixels 502. In FIG. 7B, axis 791 may be aligned with an edge rectangular shape of LCOS display pixels 502. In FIG. 7B, light sources 741, 742, 743, and 744 include rectangular emission regions and the sides of the rectangular emission regions are angularly offset by the offset angle 531 to match the angularly offset image 643. FIG. 7B shows that light source 741 is a blue light source emitting blue illumination light and light source 744 is a red light source emitting red illumination light. Light sources 742 and 743 are illustrated as green light sources emitting green illumination light. In FIG. 7B, the light sources in light source layer 706 consist of two green LEDs, one red LED, and one blue LED.

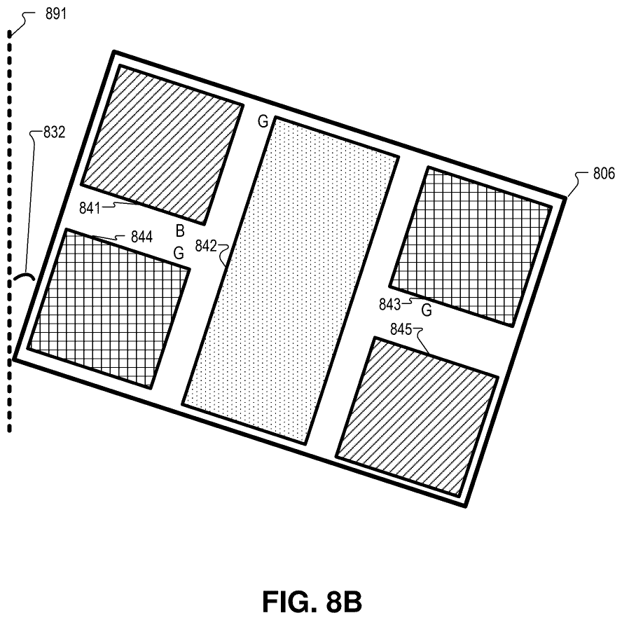

FIGS. 8A and 8B illustrate light source layers angled to illuminate the angularly offset portion 533 of LCOS display pixels 502 with illumination light, in accordance with aspects of the disclosure. FIG. 8A illustrates an example light source layer 805 including five light sources 841, 842, 843, 844 and 845. In FIG. 8A, light sources 841, 842, 843, 844 and 845 are angled at angle 831 that approximates offset angle 531. In FIG. 8A, the edge of a substrate of light source layer 805 may be aligned with an edge rectangular shape of LCOS display pixels 502. In FIG. 8A, light sources 841, 842, 843, 844 and 845 include rectangular emission regions and the sides of the rectangular emission regions are angularly offset by the offset angle 531. FIG. 8A shows that light sources 841 and 845 are blue light sources emitting blue illumination light and light sources 843 and 844 are red light sources emitting red illumination light. Light source 842 is a green light source emitting green illumination light. Green light source 842 has roughly double the emission area as individual light sources 841, 843, 844, or 845. In FIG. 8A, the light sources in light source layer 805 consist of two red LEDs, two blue LEDs, and one green LED that is larger than a single red LED or blue LED. Light sources 841, 842, 843, 844 and 845 may be mini-LEDs or laser diodes.

FIG. 8B illustrates an example light source layer 806 including four light sources 841, 842, 843, 844 and 845. In FIG. 8B, light sources 841, 842, 843, 844, and 845 are angled at angle 832 that approximates offset angle 531. In FIG. 8B, the edge of a substrate of light source layer 806 may be aligned with the edge of the angularly offset portion 533 of LCOS display pixels 502. In FIG. 8B, axis 891 may be aligned with an edge rectangular shape of LCOS display pixels 502. In FIG. 8B, light sources 841, 842, 843, 844, and 845 include rectangular emission regions and the sides of the rectangular emission regions are angularly offset by the offset angle 531. In FIG. 8B, the light sources in light source layer 806 consist of two green LEDs, one red LED, and one blue LED.

In the examples of FIGS. 7A, 7B, 8A, and 8B, the lights sources in the light source layer are five or fewer. In implementations of the disclosure, the lights sources in the light source layer are ten or fewer.

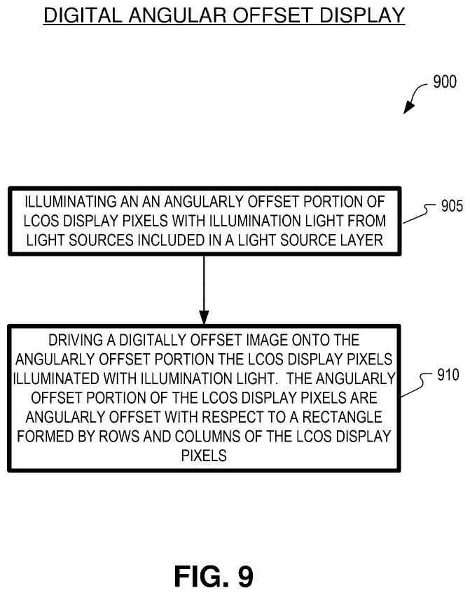

FIG. 9 illustrates a process 900 of operating a digital angular offset display, in accordance with aspects of the disclosure. The order in which some or all of the process blocks appear in process 900 should not be deemed limiting. Rather, one of ordinary skill in the art having the benefit of the present disclosure will understand that some of the process blocks may be executed in a variety of orders not illustrated, or even in parallel. All or a portion of process 900 may be executed by processing logic (e.g. processing logic 107) included in a head-mounted display such as HMD 100.

In process block 905, an angularly offset portion of LCOS display pixels is illuminated with illumination light from light sources included in a light source layer.

In process block 910, a digitally offset image is driven onto the angularly offset portion the LCOS display pixels illuminated with illumination light. The angularly offset portion of the LCOS display pixels is angularly offset with respect to a rectangle formed by rows and columns of the LCOS display pixels.

In implementations of process 900, the light sources are configured to illuminate the angularly offset portion of the LCOS display pixels without substantially illuminating a remainder of the LCOS display pixels that are not included in the angularly offset portion of the LCOS display pixels.

In implementations of process 900, the light sources in the light source layer are angled at an angle that approximates an offset angle of the angularly offset portion of the LCOS display pixel with respect to the rectangle formed by the rows and columns.

In implementations of process 900, the light sources include rectangular emission regions and sides of the rectangular emission regions are angularly offset by the offset angle.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The term “processing logic” (e.g. processing logic 107) in this disclosure may include one or more processors, microprocessors, multi-core processors, Application-specific integrated circuits (ASIC), and/or Field Programmable Gate Arrays (FPGAs) to execute operations disclosed herein. In some embodiments, memories (not illustrated) are integrated into the processing logic to store instructions to execute operations and/or store data. Processing logic may also include analog or digital circuitry to perform the operations in accordance with embodiments of the disclosure.

A “memory” or “memories” described in this disclosure may include one or more volatile or non-volatile memory architectures. The “memory” or “memories” may be removable and non-removable media implemented in any method or technology for storage of information such as computer-readable instructions, data structures, program modules, or other data. Example memory technologies may include RAM, ROM, EEPROM, flash memory, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device.

Networks may include any network or network system such as, but not limited to, the following: a peer-to-peer network; a Local Area Network (LAN); a Wide Area Network (WAN); a public network, such as the Internet; a private network; a cellular network; a wireless network; a wired network; a wireless and wired combination network; and a satellite network.

Communication channels may include or be routed through one or more wired or wireless communication utilizing IEEE 802.11 protocols, short-range wireless protocols, SPI (Serial Peripheral Interface), I²C (Inter-Integrated Circuit), USB (Universal Serial Port), CAN (Controller Area Network), cellular data protocols (e.g. 3G, 4G, LTE, 5G), optical communication networks, Internet Service Providers (ISPs), a peer-to-peer network, a Local Area Network (LAN), a Wide Area Network (WAN), a public network (e.g. “the Internet”), a private network, a satellite network, or otherwise.

A computing device may include a desktop computer, a laptop computer, a tablet, a phablet, a smartphone, a feature phone, a server computer, or otherwise. A server computer may be located remotely in a data center or be stored locally.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible non-transitory machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A head-mounted display (HMD) comprising:
a Liquid Crystal on Silicon (LCOS) display including LCOS display pixels arranged in rows and columns forming a rectangle, wherein the LCOS display is configured to drive a digitally offset image onto an angularly offset portion of the LCOS display pixels that is angularly offset from the rectangle formed by the rows and columns;
a light source layer including an array of light sources angled to illuminate the angularly offset portion of the LCOS display pixels with illumination light; and
a geometric waveguide configured to receive display light including the digitally offset image, wherein the geometric waveguide is configured to direct the display light to an eyebox region of the HMD.

2. The HMD of claim 1, wherein the light sources are configured to illuminate the angularly offset portion of the LCOS display pixels without substantially illuminating a remainder of the LCOS display pixels that are unincluded in the angularly offset portion.

3. The HMD of claim 1, the light sources in the light source layer are angled at an angle that approximates an offset angle of the angularly offset portion of the LCOS display pixel with respect to the rectangle formed by the rows and columns.

4. A display system comprising:
a Liquid Crystal on Silicon (LCOS) display including LCOS display pixels arranged in rows and columns forming a rectangle, wherein LCOS display is configured to drive a digitally offset image onto an angularly offset portion of the LCOS display pixels that is angularly offset from the rectangle formed by the rows and columns; and
a light source layer including an array of light sources angled to illuminate the angularly offset portion of the LCOS display pixels with illumination light, wherein the angularly offset portion of the LCOS display pixels is a smaller subset of the LCOS display pixels.

5. The display system of claim 4, wherein the light sources are configured to illuminate the angularly offset portion of the LCOS display pixels without substantially illuminating a remainder of the LCOS display pixels that are unincluded in the angularly offset portion.

6. The display system of claim 4, wherein the light sources in the light source layer are angled at an angle that approximates an offset angle of the angularly offset portion of the LCOS display pixel with respect to the rectangle formed by the rows and columns.

7. The display system of claim 6, wherein the light sources include rectangular emission regions, and wherein sides of the rectangular emission regions are angularly offset by the offset angle.

8. The display system of claim 7, wherein there are ten or fewer light sources in the light source layer.

9. The display system of claim 7, wherein the light sources in the light source layer consist of two green LEDs, one red LED, and one blue LED.

10. The display system of claim 7, wherein the light sources in the light source layer consist of two red LEDs, two blue LEDs, and one green LED that is larger than a single red LED or blue LED.

11. The display system of claim 7, wherein the light sources include mini-LEDs.

12. The display system of claim 7, wherein the light sources include laser diodes.

13. The display system of claim 6, wherein the angle is between 10 degrees and 45 degrees.

14. The display system of claim 4 further comprising:
a beam splitter configured to direct the illumination light to the LCOS display.

15. The display system of claim 4 further comprising:
a waveguide configured to receive display light including the digitally offset image, wherein the waveguide is configured to direct the display light to an eyebox region of a head-mounted display (HMD).

16. The display system of claim 15, wherein the waveguide includes a reflective surface angled between 20 degrees and 75 degrees with respect to the display light incident on the reflective surface.

17. A method comprising:
illuminating an angularly offset portion of Liquid Crystal on Silicon (LCOS) display pixels with illumination light from light sources included in a light source layer; and
driving a digitally offset image onto the angularly offset portion the LCOS display pixels illuminated with illumination light, wherein the angularly offset portion of the LCOS display pixels is angularly offset with respect to a rectangle formed by rows and columns of the LCOS display pixels.

18. The method of claim 17, wherein the light sources are configured to illuminate the angularly offset portion of the LCOS display pixels without substantially illuminating a remainder of the LCOS display pixels that are unincluded in the angularly offset portion of the LCOS display pixels.

19. The method of claim 17, wherein the light sources in the light source layer are angled at an angle that approximates an offset angle of the angularly offset portion of the LCOS display pixel with respect to the rectangle formed by the rows and columns.

20. The method of claim 19, wherein the light sources include rectangular emission regions, and wherein sides of the rectangular emission regions are angularly offset by the offset angle.
